(19) United States
(12) Patent Application Publication
(10) Pub. No.: US 2010/0096567 A1
(43) Pub. Date: Apr. 22, 2010

(54) REDUCTION IN STAGE MOVEMENT REACTION FORCE IN AN ELECTRON BEAM LITHOGRAPHY MACHINE

(75) Inventors: Paul George Harris, Haverhill (GB); John Melbourne Tingay, Cambridge (GB)

Correspondence Address: SUGHRUE MION, PLLC, 2100 PENNSYLVANIA AVENUE, N.W., SUITE 800, WASHINGTON, DC, 20037, US

(73) Assignee: VISTEC LITHOGRAPHY INC., Watervliet, NY (US)

(21) Appl. No.: 12/445,247

(22) PCT Filed: Oct. 11, 2007
(86) PCT No.: PCT/GB2007/003857

§ 371 Date: Apr. 10, 2009

(30) Foreign Application Priority Data
Oct. 12, 2006 (GB) 0620286.5

(51) Int. Cl. B41F 1/18

(52) U.S. Cl. 250/492.3

(57) ABSTRACT

An electron beam lithography machine (10) comprises a base structure in the form of a plinth (14), a plurality of legs (22), which preferably include pneumatic damping elements (23), for supporting the plinth relative to a support surface (24), the legs defining a support plane (A) for the plinth, an electron beam column (11) carried by the plinth and a stage (17, 18) arranged in a vacuum chamber at the plinth to be movable substantially parallel to the support plane and to carry a workpiece (13) to be acted on by an electron beam generated by the column. The centre of gravity (25) of the stage, which can be movable along X and Y axes of a co-ordinate system of the machine, is disposed in or adjacent to the support plane so that a reaction force to the stage movement is oriented in the support plane or in an adjacent, parallel plane.

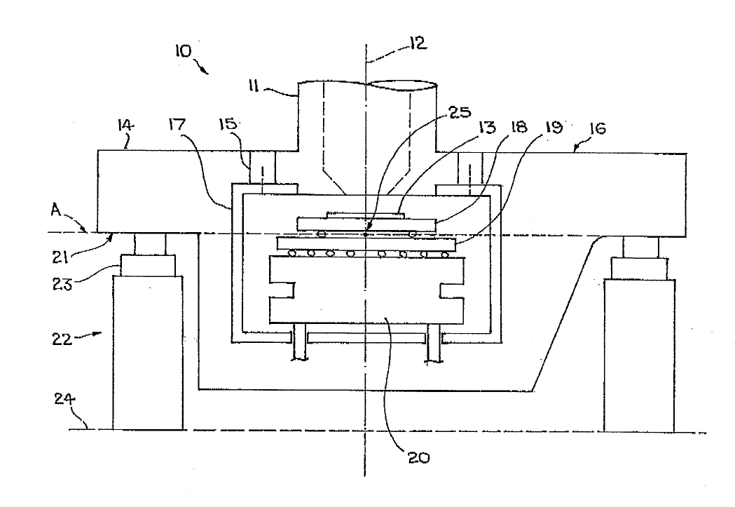

The present invention relates to an electron beam lithography machine and has particular reference to reduction in the reaction force to stage movement in such a machine.

Electron beam lithography machines are employed inter alia to write finally detailed patterns, such as integrated circuits, on suitable workpieces by the action of a focussed electron beam defining a beam writing spot, which traces pattern features through controlled deflection of the beam and periodic horizontal displacement of the workpiece. The workpiece, for example a semiconductor substrate or more commonly a mask as an intermediate element in generation of the pattern on such a substrate, is carried by a stage movable in at least one axial direction, normally in two orthogonal (X and Y) axial directions. Conventionally, the stage displacement is carried out to position the stage writing spot successively in different regions of the workpiece corresponding with individual zones or fields of the pattern and the beam deflection is carried out to cause the writing spot to trace pattern features in successive subfields of each field. The stage displacement and beam deflection are subject to close, tolerances—currently in the nanometre range—determined by laser interferometry measuring systems for detecting stage horizontal position and by precise software control of electromagnetic beam deflecting coils. The machine as a whole is highly sensitive to changes in critical dimensions and to disturbances such as vibration and incorporates suitable measures to counteract or minimise the effect of such changes and disturbances.

One persistent cause of disturbance is rocking of an electron beam column of the machine as a consequence of the stage displacement. The column is usually mounted on top of a vacuum chamber casing which encloses the stage and is in turn mounted on top of a plinth carried by supports, such as legs incorporating a damping system formed by air isolators. The column, vacuum chamber casing and plinth together represent a substantial constructional unit. The stage displacement gives rise to a net reaction force which can produce a rotational movement as a product of the stage mass, stage acceleration and stage vertical spacing from a plane of support of the unit by the legs. The air isolators are usually present at the support plane and are liable to oscillate in response to the rotational movement and thereby induce rocking of the unit. The rocking can occupy a relatively significant amount of time, for example 300 to 750 milliseconds, before the column is sufficiently quiescent for writing to continue. This has a disadvantageous effect on writing throughput in view of the number of times the stage must be moved in X and Y directions in order to write a single pattern.

Moreover, the conventional approach of mounting the electron beam column on the vacuum chamber casing and that in turn on a plinth is generally disadvantageous with respect to column stability, machine height and other constructional and operational factors.

It is therefore the principal object of the present invention to provide an electron beam lithography machine in which the reaction force to stage movement is managed so that the disadvantageous consequences of such a force, in particular rocking of an electron beam column of the machine, are reduced or even eliminated.

A subsidiary object of the invention is provision of an alternative method of association of an electron beam column, vacuum chamber casing and plinth or base structure to reduce or remove some of the disadvantages of the conventional form of column mounting.

Other objects and advantages of the invention will be apparent from the following description.

According to the present invention there is provided an electron beam lithography machine comprising a base structure, support means for supporting the base structure relative to a support surface, the support means defining a support plane for the base structure at a spacing from such surface, an electron beam column carried by the base structure and a stage arranged in a vacuum chamber at the base structure to be movable substantially parallel to the support plane and to carry a workpiece to be acted on by an electron beam generated by the column, the centre of gravity of the stage being disposed in or adjacent to the support plane so that a reaction force to the stage movement is oriented substantially in the support plane or in a plane adjacent and substantially parallel to the support plane.

The redisposition of the centre of gravity of the stage to the support plane or a plane adjacent thereto has the consequence that the reaction force to the stage movement, for example movement to position a new workpiece region in a writing zone of the focussed electron beam generated by the column, is oriented largely in that plane or at least in a closely adjacent, substantially parallel plane so that the force is not able to induce rocking or a relatively significant amount of rocking of the column and thus disrupt the writing process. Whereas in columns of conventional construction the column rocking may be of such a magnitude that a time-to-settle period of 300 to 750 milliseconds may elapse before a sufficiently quiescent state for writing continuation is attained, in the case of a machine embodying the present invention this period may be reduced to, for example, as little as 20 milliseconds. The result is greatly enhanced stability of the writing system and thus accelerated writing throughput, which is of substantial commercial significance in serial production of integrated circuits and other such mass-produced patterns requiring high resolution, accuracy and consistent reproducibility.

The stage preferably comprises an upper stage member reciprocatingly movable on a first axis and a lower stage member carrying the upper stage member and reciprocatingly movable on a second axis orthogonal to the first axis, the support plane being disposed in the vicinity of an interface of the stage members. Such a stage movement capability corresponds with the usual requirements to execute stage travel in two mutually orthogonal directions so as to allow repositioning in the electron beam writing zone of workpiece regions—which correspond with pattern main fields—displaced relative to one another in those directions. In that case the first and second axes may respectively correspond with an X axis and a Y axis of a given co-ordinate system of the machine.

The support means, for example a number of appropriately spaced support legs, may comprise a plurality of vibration damping elements, which are preferably pneumatic. Such pneumatic damping elements or air isolators provide effective damping of acoustic and other shocks affecting the stability of machine, but can themselves be the source of the already-mentioned rocking caused by a reaction moment. The measure provided by the present invention to reduce the influence of that reaction moment allows use of pneumatic or other damping elements without the same level of exposure to negative consequences.

In constructional terms the base, structure preferably comprises a plinth having a top surface and a bottom surface, the electron beam column and the vacuum chamber preferably being respectively disposed substantially above and substantially below the top surface and the support plane coinciding with the bottom surface. In that case, in a preferred embodiment the vacuum chamber can be provided in a casing carried by an annular mount incorporated in the plinth. The column can be seated on the casing, in which case the column is effectively carried by the mount, or seated directly on the mount. The plinth can thus be provided in its top surface with a mounting ring or similar from which the vacuum chamber casing can be suspended, so that the casing is located largely or entirely below and the column largely or entirely above that top surface. The bottom surface of the plinth lies in the support plane at which the support means, for example legs with air isolators, support the unit of plinth column and casing. It is therefore possible for the stage within the casing to be located with its centre of gravity in the plane of the bottom surface of the plinth, i.e. the support plane, or very close to that plane. Such a location is not possible if—as in the case of prior art machines—the vacuum chamber containing the casing is mounted on top of the plinth so that the stage is not only above the top surface of the plinth, but also far above the bottom surface of the plinth and thus significantly spaced from the plane where the reaction force to stage movement is largely neutral.

An embodiment of the present invention will now be more particularly described by way of example with reference to the accompanying drawing, the single FIGURE of which is a schematic elevation of part of an electron beam lithography machine embodying the invention.

Referring now to the drawing there is shown part of an electron beam lithography machine 10 intended for, in particular, writing integrated circuit patterns on suitable substrates. Conventionally, such patterns are fractured into main fields each containing a respective area of the pattern and each main field is in turn fractured into subfields containing pattern features of that area. Writing is normally carried out by deflecting an electron beam, which is generated in the machine to trace the subfield pattern features on the substrate by a focussed beam spot, i.e. writing spot, and periodic movement of the substrate to locate different regions thereof, which correspond with successive main fields, in a zone of writing action of the beam spot, in particular a zone able to be scanned by the beam deflection. Pattern writing procedures are well-known and for that reason are not discussed in further detail.

The machine 10 comprises an electron beam column 11 in which an electron beam is generated to propagate along the axis 12 of the column for action on a workpiece 13 located below the column, internal features of the column being shown in dashed lines. The column 11 is mounted on a base structure which comprises a plinth 14 with a steel mounting ring 15 recessed into the plinth at a top surface 16 thereof, a lower end section of the column being received in the ring. The column 11 is thus located above the top surface apart from its end section within the ring. The ring 15 is rigidly fixed in the plinth, which is itself a rigid body preferably of a composite material with a low coefficient of thermal expansion and a high level of damping with respect to mechanically sourced vibrations. Fixing of the ring can be achieved by moulding the material of the body around the ring so that the ring is embedded in the material.

Attached to the underside of the ring 15 by screws (shown in dashed lines) is a vacuum chamber casing 17, the interior of which can be evacuated to provide an appropriate environment for the electron beam and disturbance-free writing on the workpiece 13, which is located in the evacuated interior of the casing, i.e. vacuum chamber. The column 11 is seated on the top of the casing 17 and thus effectively carried by the ring. The column could, however, be seated directly on a shoulder of the ring itself. Either approach provides particularly stable mounting of the column without susceptibility to disturbances caused by, for example, thermally induced expansion and contraction of the vacuum casing as a whole.

Also located within the vacuum chamber is a stage comprising an upper stage member 18 horizontally displaceable along an X axis of a co-ordinate system of the machine and a lower stage member 19 horizontally displaceable along a Y axis of the co-ordinate system and carrying the upper member stage 18. The lower stage member 19 can be supported on a table 20 optionally vertically displaceable along a Z axis of the same co-ordinate system; this vertical displacement may be provided for workpiece height correction and thus limited to a very small range of travel.

The plinth 14 is supported at a bottom surface 21 thereof on support means, which has the form of four legs 22 each incorporating a respective pneumatic damping element 23, at a spacing from a floor 24 or other support surface. The bottom surface 21 or the top faces of the legs 22, in particular of the pneumatic damping elements, thus defines or define a support plane A of the plinth 14. The damping elements 23, also termed air isolators, function with a compressed air pressure of about 5 bars and effectively isolate the plinth 14 and machine components it carries from mechanical shocks liable to adversely affect the sensitive measuring and beam spot placement systems of the machine.

Displacement of the stage members 17 and 18 is carried out to position successive pattern main field regions, in both X and Y axial directions, of the workpiece 13 in the zone of action of the column-generated electron beam. The stage member displacements generate reaction forces which, due to mechanical coupling of the stage members to the vacuum chamber casing 17, are transmitted via the casing, mounting ring 15 and plinth 14 to the damping elements 23 of the legs 22. In order to avoid or minimise oscillation of the elements as a consequence of the transmitted reaction forces, the centre of gravity 25 of the stage is located approximately in the support plane A of the plinth, thus the plane of the bottom surface 21 of the plinth or top faces of the damping elements 23. The transmitted reaction force is thereby largely neutralised, in particular does not produce a significant rotational movement acting on the damping elements to induce oscillation which may cause an enduring rocking motion of the column. Any tendency of the column 11 to rock as a result of oscillation of the damping elements 23 attributable to horizontal stage displacement can be significantly reduced, if not entirely eliminated, by the described measures. The time for the column to settle to a stable state for writing purposes without detrimental shake of the focussed electron beam may be able to be reduced to, for example, approximately 20 milliseconds.

The centre of gravity 25 is, as stated, depicted to lie in the support plane A, but may equally well lie in a plane slightly above or below the support plane.

The mounting of the column 11 virtually on the top surface 16 of the plinth 11 and the mounting of the vacuum chamber casing 17 closely below that surface via the intermediary of the ring 15 yields a particularly sturdy and robust structural unit without the need for the casing as a whole to be load-bearing in the sense of support of the column. This simplifies production of the casing and, with appropriate design of the ring, may ease removal of the column for maintenance purposes. In addition, the constructional height of the machine may be able to be reduced and with it the tendency of the column to rock as a consequence of vibrations from sources other than the stage displacement. The machine as a whole thus has reduced sensitivity to disturbance and, as a result, an enhanced writing capability.

1-9. (canceled)

10. An electron beam lithography machine comprising:
a base structure incorporating a vacuum chamber;
support means for supporting the base structure relative to a support surface, the support means defining a support plane for the base structure at a spacing from the support surface;
an electron beam column carried by the base structure, the electron beam column being operable to generate an electron beam; and
a stage arranged in the vacuum chamber to be movable substantially parallel to the support plane and to carry a workpiece to be acted on by the electron beam;
the centre of gravity of the stage being arranged in or approximately in the support plane so that any reaction force to the movement of the stage is oriented substantially in the support plane or in a plane adjacent and substantially parallel to the support plane.

11. A machine according to claim 10, wherein the stage comprises an upper stage member reciprocatingly movable on a first axis and a lower stage member carrying the upper stage member and reciprocatingly movable on a second axis orthogonal to the first axis, the support plane being disposed in the vicinity of an interface of the stage members.

12. A machine according to claim 11, wherein the first axis and the second axis respectively correspond with an X axis and a Y axis of a predetermined co-ordinate system of the machine.

13. A machine according to claim 10, the support means comprising a plurality of vibration damping elements.

14. A machine according to claim 13, wherein the damping elements are pneumatic.

15. A machine according to claim 10, wherein the base structure comprises a plinth defining a top surface and a bottom surface, the electron beam column and the vacuum chamber being respectively disposed substantially above and substantially below the top surface, and the support plane coinciding with the bottom surface.

16. A machine according to claim 15, wherein the base structure comprises a casing bounding the vacuum chamber, and an annular mount carrying the casing and incorporated in the plinth.

17. A machine according to claim 16, wherein the electron beam column is seated on the casing.

18. A machine according to claim 16, wherein the electron beam column is seated on the annular mount.
